(19) United States
(12) Patent Application Publication
(10) Pub. No.: US 2026/0220799 A1
(43) Pub. Date: Jul. 30, 2026

(54) COMPUTING A HYBRID SURFACE FROM MEDICAL IMAGE DATA USING TRUSTED REGIONS AND A PLAUSIBILITY CHECK

(71) Applicant: Brainlab AG, Munich (DE)

(72) Inventors: Kajetan BERLINGER, Munich (DE); Hagen KAISER, Munich (DE)

(21) Appl. No.: 19/142,409

(22) PCT Filed: Feb. 3, 2023
(86) PCT No.: PCT/EP2023/052639

§ 371 Date: Jun. 23, 2025

(51) Int. Cl. G06T 7/33

(52) U.S. Cl. CPC G06T 7/344; G06T 2207/10028; G06T 2207/10081; G06T 2207/20224; G06T 2207/30008

(57) ABSTRACT

This disclosure encompasses approaches for determining whether an anatomical region is suitable for comparing the planning image (the CT) to the live positioning image (a surface camera image) or whether it is likely to be subject to deformation for example due to swelling and thus generally an undesirable basis for patient positioning. A first method aims at using anatomical regions that are likely not to be subject to such behavior as basis for establishing a positional relationship between the planning image and the live positioning image. A second method aims at determining whether differences in image contents between the planning image and the live positioning image are plausible, for example acceptable, due to known effects occurring when positioning the patient.

### FIELD OF THE INVENTION

The present invention relates to a computer-implemented method of determining a spatial transformation between sets of medical image data and a computer-implemented medical method of determining a plausibility of a difference in image content between sets of medical image data, a corresponding computer program, a computer-readable storage medium storing such a program and a computer executing the program, as well as a medical system comprising an electronic data storage device and the aforementioned computer.

### TECHNICAL BACKGROUND

In surface-guided radiotherapy (SGRT), a first reference in most cases is the outer contour, i.e. the silhouette of the patient, also referred to as CT contour, as derived from the planning CT. The patient is e.g. pre-positioned or even finally positioned for treatment by comparing live surface images as retrieved from a surface camera to the reference, e.g. the CT contour. Once the patient thereby is aligned in the first treatment session, many clinicians desire to be able to save the surface as retrieved by the surface camera in final position, and to re-use this surface as reference for next sessions instead of the CT contour. However, the patient's silhouette may differ between the CT image and the live image used for the actual positioning due to radiation-induced swelling of soft tissue or shadowing due to for example the adequate positioning of body parts such as the upper arms which are frequently placed in an upward position during radiotherapy of structures inside the thorax.

The present invention has the object of avoiding a mispositioning of the patient due to a difference between the image content of the planning image and the image content of the live image used for the actual positioning.

The present invention can be used for patient positioning procedures e.g. in connection with a system for image-guided radiotherapy such as ExacTrac®, a product of Brainlab AG.

Aspects of the present invention, examples and exemplary steps and their embodiments are disclosed in the following. Different exemplary features of the invention can be combined in accordance with the invention wherever technically expedient and feasible.

### EXEMPLARY SHORT DESCRIPTION OF THE INVENTION

In the following, a short description of the specific features of the present invention is given which shall not be understood to limit the invention only to the features or a combination of the features described in this section.

This disclosure encompasses approaches for determining whether an anatomical region is suitable for comparing the planning image (the CT) to the live positioning image (a surface camera image) or whether it is likely to be subject to deformation for example due to swelling and thus generally an undesirable basis for patient positioning. A first method aims at using only anatomical regions which are likely not to be subject to such behaviour as basis for establishing a positional relationship between the planning image and the live positioning image. A second method aims at determining whether differences in image contents between the planning image and the live positioning image are plausible, for example acceptable due to known effects occurring when positioning the patient.

### GENERAL DESCRIPTION OF THE INVENTION

In this section, a description of the general features of the present invention is given for example by referring to possible embodiments of the invention.

The invention reaches the aforementioned object by providing, in a first aspect, a computer-implemented medical method of determining a spatial transformation between sets of medical image data. The method comprises executing, on at least one processor of at least one computer (for example at least one computer being part of a navigation system), the following exemplary steps which are executed by the at least one processor.

In a (for example first) exemplary step of the method according to the first aspect, first medical data is acquired which describes a first representation of an anatomical body part, wherein positions of the first representation are defined in a first reference system. For example, the anatomical body part comprises an exterior surface of a patient's body. Such a surface can be digitally extracted from the first medical image data.

In a (for example second) exemplary step of the method according to the first aspect, second medical data is acquired which describes a second representation of the anatomical body part, wherein positions of the second representation are defined in a second reference system.

For example, the first representation and the second representation have been generated using different imaging modalities, for example the first representation has been generated using computed x-ray tomography and the second representation has been generated using a point cloud generating device such as a surface camera. In other examples, the first representation has been generated using magnetic resonance tomography or ultrasound tomography, and the second representation has been generated using x-ray imaging, for example two-dimensional x-ray imaging.

In a (for example third) exemplary step of the method according to the first aspect, body part model data is acquired which describes a digital model of the anatomical body part and at least one weight, for example predetermined weight, assigned to at least one unit such as a pixel or voxel of the digital model describing a trust assigned to the respective at least one unit. For example, the digital model comprises or is associated with annotations describing the trust for at least one anatomical body part described by the digital model. The trust, for example the weight, is set in dependence on the movability of at least one anatomical body part described by the digital model, for example set higher for regions of comparably low anatomic movability, e.g. deformability, preferably bone or cartilage, e.g. the sternum, and lower for regions of comparably high anatomic movability, e.g. soft tissue. In an example, the body part model data comprises or consists of atlas data describing the digital model and comprising or being associated with annotations describing the trust for at lost one anatomical body part described by the digital model.

In a (for example fourth) exemplary step of the method according to the first aspect, trusted region data is determined which describes a selection, for example a trusted region, of at least part of at least one of the first representation and the second representation, wherein the trusted region data is determined based on the body part model data and the respective one of at least one of the first medical data and the second medical data by establishing an assignment between the at least part of the respective one of the first representation and the second representation on the one hand and the at least one weight on the other hand. The selection is defined for example such that only a trusted region can be part of the selection.

In a (for example fifth) exemplary step of the method according to the first aspect, spatial transformation data is determined (S15) based on the first medical data and the second medical data and the trusted region data, for example by taking into account and/or including only those parts of the first and/or second representation corresponding to a trusted region, wherein the spatial transformation data describes a spatial transformation between the first reference system and the second reference system. For example, the spatial transformation data is determined by selecting, for example selecting only, from the respective one of the first representation and the second representation, the at least part of the respective one of the first representation and the second representation based on the assigned weight for establishing the transformation, for example for matching the first representation with the second representation.

For example, the method according to the first aspect comprises acquiring threshold data describing a, for example at least one, threshold for the at least one weight. For example, the threshold is predetermined. Selection data is then determined based on the body part model data and the threshold data, wherein the selection data describes whether the at least part of the respective one of the first representation and the second representation is to be determined as part of the selection, wherein the trusted region data is determined based on the selection data. For example, the at least part of the respective one of the first representation and the second representation is determined to be part of the selection if the at least one weight assigned to the at least part of the respective one of the first representation and the second representation fulfils a predetermined relationship to the threshold.

In an example of the method according to the first aspect, merging data is determined based on the spatial transformation data and the first medical data and the second medical data, wherein the merging data describes a merging of the first representation and the second representation, for example a merging of point clouds extracted from the first representation and the second representation. For example, the merging comprises only the selection of at least part of at least one of the first representation and the second representation, and corresponding constituents of the other one of the at least one of the first representation and the second representation. For example, merging rule data is acquired which is used as a basis for determining the merging data, wherein the merging rule data describes merging rules indicating that if the first representation and the second representation, for example point clouds extracted from the first representation and the second representation, comprise data points which are at least substantially redundant, only the respective data point from the respective one of the first or second representation or the data point from the one of the first medical image data or the second medical image data which was generated later in time or a data point from the one of the first medical image data or the second medical image which depends on the identity of the anatomical body part is included in the merging.

The invention reaches the aforementioned object by providing, in a second aspect, a computer-implemented medical method of determining a plausibility of a difference in image content between sets of medical image data. The method comprises executing, on at least one processor of at least one computer (for example at least one computer being part of a navigation system), the following exemplary steps which are executed by the at least one processor.

In a (for example first) exemplary step of the method according to the second aspect, first medical data is acquired which describes a first representation of an anatomical body part, wherein positions of the first representation are defined in a first reference system.

The set of imaging modalities usable for generating the first medical data and the second medical data within the framework of the method according to the second aspect is the same as for generating the first medical data and the second medical data within the framework of the method according to the first aspect.

In a (for example second) exemplary step of the method according to the second aspect, second medical data is acquired which describes a second representation of at least part of the anatomical body part, wherein positions of the second representation are defined in a second reference system.

In a (for example third) exemplary step of the method according to the second aspect, spatial relationship data is acquired which describes a spatial transformation between the first reference system and the second reference system. The spatial transformation is for example predetermined, for example known, and serves as an input to the method according to the second aspect.

In a (for example fourth) exemplary step of the method according to the second aspect, plausibility model data is acquired which describes a digital model of the anatomical body part and information about degrees of freedom of the digital model. For example, the digital model is a skeleton model. In another example, the digital model has been trained using deep learning.

In a (for example fifth) exemplary step of the method according to the second aspect, representation difference data is determined based on the first medical data and the second medical data, for example based on the merging of the first medical data and the second medical data, and the spatial transformation data, wherein the representation difference data describes a difference between the first representation and the second representation. The representation difference data is determined for example by comparing the first representation and the second representation.

In a (for example sixth) exemplary step of the method according to the second aspect, plausibility check data is determined based on the plausibility model data and the second medical data and the representation difference data, wherein the plausibility check data describes the plausibility of the difference. For example, the difference is a difference in depicted anatomy, for example depicted in the first representation and the second representation. For example, the second representation describes less of the anatomical body part than the first representation, and the difference is defined accordingly. This difference may be due to optical shading from the perspective of an imaging device used to generate the second medical data onto the anatomical body part.

In an example, the method according to the second aspect comprises acquiring medical image data describing a two-dimensional, for example x-ray, image of a part of the anatomical body part which is described by the second representation, and acquiring the plausibility model data based on the medical image data by extracting the image constituents describing the part of the anatomical body part and generating the digital model from the extracted image constituents.

In an example, the method according to the second aspect comprises determining difference supplement data based on the second medical image data and the representation difference data, wherein the difference supplement data describes a supplementation of the second representation with the difference in consideration of the degrees of freedom of the digital model, wherein the plausibility check data is determined based on the body part model data and the difference supplement data. For example, the difference supplement data describes whether the second representation can be supplemented with the difference in consideration of the degrees of freedom of the digital model. For example, the plausibility check data describes that the difference between the first representation and the second representation is plausible if the difference supplement data describes a corresponding supplementation or that a corresponding supplementation exists. For example, the plausibility check data is determined by determining whether there is a correspondence between the supplementation and the first representation. For example, the plausibility check data describes that the difference is plausible if the comparison of the first representation and the second representation results in that the correspondence exists at least substantially, for example exists.

In an example of the method according to the second aspect, the plausibility check data describes that the difference is plausible, and the method comprises determining surface data based on the second medical data, wherein the surface data describes an exterior surface of the at least part of the anatomical body part. For example, the surface data is determined based on the second medical data if the plausibility check data describes that the difference is plausible. The surface data can be stored in a for example non-transitory manner for later use, for example during subsequent procedures for positioning the patient for radiation treatment such as radiotherapy or radiosurgery.

In a third aspect, the invention is directed to a computer program comprising instructions which, when the program is executed by at least one computer, causes the at least one computer to carry out method according to the first and second aspects. The invention may alternatively or additionally relate to a (physical, for example electrical, for example technically generated) signal wave, for example a digital signal wave, such as an electromagnetic carrier wave carrying information which represents the program, for example the aforementioned program, which for example comprises code means which are adapted to perform any or all of the steps of the methods according to the first and second aspects. The signal wave is in one example a data carrier signal carrying the aforementioned computer program. A computer program stored on a disc is a data file, and when the file is read out and transmitted it becomes a data stream for example in the form of a (physical, for example electrical, for example technically generated) signal. The signal can be implemented as the signal wave, for example as the electromagnetic carrier wave which is described herein. For example, the signal, for example the signal wave is constituted to be transmitted via a computer network, for example LAN, WLAN, WAN, mobile network, for example the internet. For example, the signal, for example the signal wave, is constituted to be transmitted by optic or acoustic data transmission. The invention according to the second aspect therefore may alternatively or additionally relate to a data stream representative of the aforementioned program, i.e. comprising the program.

In a fourth aspect, the invention is directed to a computer-readable storage medium on which the program according to the second aspect is stored. The program storage medium is for example non-transitory.

In a fifth aspect, the invention is directed to at least one computer (for example, a computer), comprising at least one processor (for example, a processor), wherein the program according to the second aspect is executed by the processor, or wherein the at least one computer comprises the computer-readable storage medium according to the third aspect.

In a sixth aspect, the invention is directed to a medical system, comprising:
a) the at least one computer according to the fifth aspect;
b) at least one electronic data storage device storing at least the patient data; and
c) a medical device for carrying out a medical procedure on the patient, wherein the at least one computer is operably coupled to
   the at least one electronic data storage device for acquiring, from the at least one data storage device, at least the first medical data and the second medical data and the plausibility model data and, as far as the program, when the program is executed by the computer, causes the computer to carry out the method according to the first aspect, the spatial relationship data, and
   the medical device for issuing a control signal to the medical device for controlling the operation of the medical device on the basis of, as far as the as far as the program, when the program is executed by the computer, causes the computer to carry out the method according to the first aspect, the spatial transformation data or as far as the as far as the program, when the program is executed by the computer, causes the computer to carry out the method according to the second aspect, the plausibility check data, or as far as the as far as the program, when the program is executed by the computer, causes the computer to carry out the method according to determine the surface data, the surface data.

In an example, the system according to the sixth aspect, the system comprises
a radiation treatment apparatus comprising a treatment beam source and a patient support unit,
wherein the at least one computer is operably coupled to the radiation treatment apparatus for issuing the control signal to the radiation treatment apparatus for controlling, on the basis of the control signal, at least one of
   the operation of the treatment beam source or
   the position of the patient support unit.

For example, the disclosed method is not a method for treatment of the human or animal body by surgery or therapy. For example, the invention does not involve or in particular comprise or encompass an invasive step which would represent a substantial physical interference with the body requiring professional medical expertise to be carried out and entailing a substantial health risk even when carried out with the required professional care and expertise.

For example, the invention does not comprise a step of treating the human or animal body by radiation treatment such as radiotherapy or radiosurgery. More particularly, the invention does not involve or in particular comprise or encompass any surgical or therapeutic activity. The invention is instead directed as applicable to planning, for example preparing, positioning a patient in a state ready for a medical procedure. For this reason alone, no surgical or therapeutic activity and in particular no surgical or therapeutic step is necessitated or implied by carrying out the invention.

The present invention also relates to the use of the system according to the sixth aspect for conducting a medical procedure, wherein the use comprises execution of the steps of the method according to the first or second aspect for controlling the medical device.

### DEFINITIONS

In this section, definitions for specific terminology used in this disclosure are offered which also form part of the present disclosure.

The method in accordance with the invention is for example a computer-implemented method. For example, all the steps or merely some of the steps (i.e. less than the total number of steps) of the method in accordance with the invention can be executed by a computer (for example, at least one computer). An embodiment of the computer implemented method is a use of the computer for performing a data processing method. An embodiment of the computer implemented method is a method concerning the operation of the computer such that the computer is operated to perform one, more or all steps of the method.

The computer for example comprises at least one processor and for example at least one memory in order to (technically) process the data, for example electronically and/or optically. The processor being for example made of a substance or composition which is a semiconductor, for example at least partly n-and/or p-doped semiconductor, for example at least one of II-, III-, IV-, V-, VI-semiconductor material, for example (doped) silicon and/or gallium arsenide. The calculating or determining steps described are for example performed by a computer. Determining steps or calculating steps are for example steps of determining data within the framework of the technical method, for example within the framework of a program. A computer is for example any kind of data processing device, for example electronic data processing device. A computer can be a device which is generally thought of as such, for example desktop PCs, notebooks, netbooks, etc., but can also be any programmable apparatus, such as for example a mobile phone or an embedded processor. A computer can for example comprise a system (network) of “sub-computers”, wherein each sub-computer represents a computer in its own right. The term “computer” includes a cloud computer, for example a cloud server. The term computer includes a server resource. The term “cloud computer” includes a cloud computer system which for example comprises a system of at least one cloud computer and for example a plurality of operatively interconnected cloud computers such as a server farm. Such a cloud computer is preferably connected to a wide area network such as the world wide web (WWW) and located in a so-called cloud of computers which are all connected to the world wide web. Such an infrastructure is used for “cloud computing”, which describes computation, software, data access and storage services which do not require the end user to know the physical location and/or configuration of the computer delivering a specific service. For example, the term “cloud” is used in this respect as a metaphor for the Internet (world wide web). For example, the cloud provides computing infrastructure as a service (IaaS). The cloud computer can function as a virtual host for an operating system and/or data processing application which is used to execute the method of the invention. The cloud computer is for example an elastic compute cloud (EC2) as provided by Amazon Web Services™. A computer for example comprises interfaces in order to receive or output data and/or perform an analogue-to-digital conversion. The data are for example data which represent physical properties and/or which are generated from technical signals. The technical signals are for example generated by means of (technical) detection devices (such as for example devices for detecting marker devices) and/or (technical) analytical devices (such as for example devices for performing (medical) imaging methods), wherein the technical signals are for example electrical or optical signals. The technical signals for example represent the data received or outputted by the computer. The computer is preferably operatively coupled to a display device which allows information outputted by the computer to be displayed, for example to a user. One example of a display device is a virtual reality device or an augmented reality device (also referred to as virtual reality glasses or augmented reality glasses) which can be used as “goggles” for navigating. A specific example of such augmented reality glasses is Google Glass (a trademark of Google, Inc.). An augmented reality device or a virtual reality device can be used both to input information into the computer by user interaction and to display information outputted by the computer. Another example of a display device would be a standard computer monitor comprising for example a liquid crystal display operatively coupled to the computer for receiving display control data from the computer for generating signals used to display image information content on the display device. A specific embodiment of such a computer monitor is a digital lightbox. An example of such a digital lightbox is Buzz®, a product of Brainlab AG. The monitor may also be the monitor of a portable, for example handheld, device such as a smart phone or personal digital assistant or digital media player.

The invention also relates to a computer program comprising instructions which, when on the program is executed by a computer, cause the computer to carry out the method or methods, for example, the steps of the method or methods, described herein and/or to a computer-readable storage medium (for example, a non-transitory computer-readable storage medium) on which the program is stored and/or to a computer comprising said program storage medium and/or to a (physical, for example electrical, for example technically generated) signal wave, for example a digital signal wave, such as an electromagnetic carrier wave carrying information which represents the program, for example the aforementioned program, which for example comprises code means which are adapted to perform any or all of the method steps described herein. The signal wave is in one example a data carrier signal carrying the aforementioned computer program. The invention also relates to a computer comprising at least one processor and/or the aforementioned computer-readable storage medium and for example a memory, wherein the program is executed by the processor.

Within the framework of the invention, computer program elements can be embodied by hardware and/or software (this includes firmware, resident software, micro-code, etc.). Within the framework of the invention, computer program elements can take the form of a computer program product which can be embodied by a computer-usable, for example computer-readable data storage medium comprising computer-usable, for example computer-readable program instructions, “code” or a “computer program” embodied in said data storage medium for use on or in connection with the instruction-executing system. Such a system can be a computer; a computer can be a data processing device comprising means for executing the computer program elements and/or the program in accordance with the invention, for example a data processing device comprising a digital processor (central processing unit or CPU) which executes the computer program elements, and optionally a volatile memory (for example a random access memory or RAM) for storing data used for and/or produced by executing the computer program elements. Within the framework of the present invention, a computer-usable, for example computer-readable data storage medium can be any data storage medium which can include, store, communicate, propagate or transport the program for use on or in connection with the instruction-executing system, apparatus or device. The computer-usable, for example computer-readable data storage medium can for example be, but is not limited to, an electronic, magnetic, optical, electromagnetic, infrared or semiconductor system, apparatus or device or a medium of propagation such as for example the Internet. The computer-usable or computer-readable data storage medium could even for example be paper or another suitable medium onto which the program is printed, since the program could be electronically captured, for example by optically scanning the paper or other suitable medium, and then compiled, interpreted or otherwise processed in a suitable manner. The data storage medium is preferably a non-volatile data storage medium. The computer program product and any software and/or hardware described here form the various means for performing the functions of the invention in the example embodiments. The computer and/or data processing device can for example include a guidance information device which includes means for outputting guidance information. The guidance information can be outputted, for example to a user, visually by a visual indicating means (for example, a monitor and/or a lamp) and/or acoustically by an acoustic indicating means (for example, a loudspeaker and/or a digital speech output device) and/or tactilely by a tactile indicating means (for example, a vibrating element or a vibration element incorporated into an instrument). For the purpose of this document, a computer is a technical computer which for example comprises technical, for example tangible components, for example mechanical and/or electronic components. Any device mentioned as such in this document is a technical and for example tangible device.

The expression “acquiring data” for example encompasses (within the framework of a computer implemented method) the scenario in which the data are determined by the computer implemented method or program. Determining data for example encompasses measuring physical quantities and transforming the measured values into data, for example digital data, and/or computing (and e.g. outputting) the data by means of a computer and for example within the framework of the method in accordance with the invention. A step of “determining” as described herein for example comprises or consists of issuing a command to perform the determination described herein. For example, the step comprises or consists of issuing a command to cause a computer, for example a remote computer, for example a remote server, for example in the cloud, to perform the determination. Alternatively or additionally, a step of “determination” as described herein for example comprises or consists of receiving the data resulting from the determination described herein, for example receiving the resulting data from the remote computer, for example from that remote computer which has been caused to perform the determination. The meaning of “acquiring data” also for example encompasses the scenario in which the data are received or retrieved by (e.g. input to) the computer implemented method or program, for example from another program, a previous method step or a data storage medium, for example for further processing by the computer implemented method or program. Generation of the data to be acquired may but need not be part of the method in accordance with the invention. The expression “acquiring data” can therefore also for example mean waiting to receive data and/or receiving the data. The received data can for example be inputted via an interface. The expression “acquiring data” can also mean that the computer implemented method or program performs steps in order to (actively) receive or retrieve the data from a data source, for instance a data storage medium (such as for example a ROM, RAM, database, hard drive, etc.), or via the interface (for instance, from another computer or a network). The data acquired by the disclosed method or device, respectively, may be acquired from a database located in a data storage device which is operably to a computer for data transfer between the database and the computer, for example from the database to the computer. The computer acquires the data for use as an input for steps of determining data. The determined data can be output again to the same or another database to be stored for later use. The database or database used for implementing the disclosed method can be located on network data storage device or a network server (for example, a cloud data storage device or a cloud server) or a local data storage device (such as a mass storage device operably connected to at least one computer executing the disclosed method). The data can be made “ready for use” by performing an additional step before the acquiring step. In accordance with this additional step, the data are generated in order to be acquired. The data are for example detected or captured (for example by an analytical device). Alternatively or additionally, the data are inputted in accordance with the additional step, for instance via interfaces. The data generated can for example be inputted (for instance into the computer). In accordance with the additional step (which precedes the acquiring step), the data can also be provided by performing the additional step of storing the data in a data storage medium (such as for example a ROM, RAM, CD and/or hard drive), such that they are ready for use within the framework of the method or program in accordance with the invention. The step of “acquiring data” can therefore also involve commanding a device to obtain and/or provide the data to be acquired. In particular, the acquiring step does not involve an invasive step which would represent a substantial physical interference with the body, requiring professional medical expertise to be carried out and entailing a substantial health risk even when carried out with the required professional care and expertise. In particular, the step of acquiring data, for example determining data, does not involve a surgical step and in particular does not involve a step of treating a human or animal body using surgery or therapy. In order to distinguish the different data used by the present method, the data are denoted (i.e. referred to) as “XY data” and the like and are defined in terms of the information which they describe, which is then preferably referred to as “XY information” and the like.

Preferably, atlas data is acquired which describes (for example defines, more particularly represents and/or is) a general three-dimensional shape of the anatomical body part. The atlas data therefore represents an atlas of the anatomical body part. An atlas typically consists of a plurality of generic models of objects, wherein the generic models of the objects together form a complex structure. For example, the atlas constitutes a statistical model of a patient's body (for example, a part of the body) which has been generated from anatomic information gathered from a plurality of human bodies, for example from medical image data containing images of such human bodies. In principle, the atlas data therefore represents the result of a statistical analysis of such medical image data for a plurality of human bodies. This result can be output as an image-the atlas data therefore contains or is comparable to medical image data. Such a comparison can be carried out for example by applying an image fusion algorithm which conducts an image fusion between the atlas data and the medical image data. The result of the comparison can be a measure of similarity between the atlas data and the medical image data. The atlas data comprises image information (for example, positional image information) which can be matched (for example by applying an elastic or rigid image fusion algorithm) for example to image information (for example, positional image information) contained in medical image data so as to for example compare the atlas data to the medical image data in order to determine the position of anatomical structures in the medical image data which correspond to anatomical structures defined by the atlas data.

The human bodies, the anatomy of which serves as an input for generating the atlas data, advantageously share a common feature such as at least one of gender, age, ethnicity, body measurements (e.g. size and/or mass) and pathologic state. The anatomic information describes for example the anatomy of the human bodies and is extracted for example from medical image information about the human bodies. The atlas of a femur, for example, can comprise the head, the neck, the body, the greater trochanter, the lesser trochanter and the lower extremity as objects which together make up the complete structure. The atlas of a brain, for example, can comprise the telencephalon, the cerebellum, the diencephalon, the pons, the mesencephalon and the medulla as the objects which together make up the complex structure. One application of such an atlas is in the segmentation of medical images, in which the atlas is matched to medical image data, and the image data are compared with the matched atlas in order to assign a point (a pixel or voxel) of the image data to an object of the matched atlas, thereby segmenting the image data into objects.

For example, the atlas data includes information of the anatomical body part. This information is for example at least one of patient-specific, non-patient-specific, indication-specific or non-indication-specific. The atlas data therefore describes for example at least one of a patient-specific, non-patient-specific, indication-specific or non-indication-specific atlas. For example, the atlas data includes movement information indicating a degree of freedom of movement of the anatomical body part with respect to a given reference (e.g. another anatomical body part). For example, the atlas is a multimodal atlas which defines atlas information for a plurality of (i.e. at least two) imaging modalities and contains a mapping between the atlas information in different imaging modalities (for example, a mapping between all of the modalities) so that the atlas can be used for transforming medical image information from its image depiction in a first imaging modality into its image depiction in a second imaging modality which is different from the first imaging modality or to compare (for example, match or register) images of different imaging modality with one another.

In the field of medicine, imaging methods (also called imaging modalities and/or medical imaging modalities) are used to generate image data (for example, two-dimensional or three-dimensional image data) of anatomical structures (such as soft tissues, bones, organs, etc.) of the human body. The term “medical imaging methods” is understood to mean (advantageously apparatus-based) imaging methods (for example so-called medical imaging modalities and/or radiological imaging methods) such as for instance computed tomography (CT) and cone beam computed tomography (CBCT, such as volumetric CBCT), x-ray tomography, magnetic resonance tomography (MRT or MRI), conventional x-ray, sonography and/or ultrasound examinations, and positron emission tomography. For example, the medical imaging methods are performed by the analytical devices. Examples for medical imaging modalities applied by medical imaging methods are: X-ray radiography, magnetic resonance imaging, medical ultrasonography or ultrasound, endoscopy, elastography, tactile imaging, thermography, medical photography and nuclear medicine functional imaging techniques as positron emission tomography (PET) and Single-photon emission computed tomography (SPECT), as mentioned by Wikipedia. The image data thus generated is also termed “medical imaging data”. Analytical devices for example are used to generate the image data in apparatus-based imaging methods. The imaging methods are for example used for medical diagnostics, to analyse the anatomical body in order to generate images which are described by the image data. The imaging methods are also for example used to detect pathological changes in the human body. However, some of the changes in the anatomical structure, such as the pathological changes in the structures (tissue), may not be detectable and for example may not be visible in the images generated by the imaging methods. A tumour represents an example of a change in an anatomical structure. If the tumour grows, it may then be said to represent an expanded anatomical structure. This expanded anatomical structure may not be detectable; for example, only a part of the expanded anatomical structure may be detectable. Primary/high-grade brain tumours are for example usually visible on MRI scans when contrast agents are used to infiltrate the tumour. MRI scans represent an example of an imaging method. In the case of MRI scans of such brain tumours, the signal enhancement in the MRI images (due to the contrast agents infiltrating the tumour) is considered to represent the solid tumour mass. Thus, the tumour is detectable and for example discernible in the image generated by the imaging method. In addition to these tumours, referred to as “enhancing” tumours, it is thought that approximately 10% of brain tumours are not discernible on a scan and are for example not visible to a user looking at the images generated by the imaging method.

### BRIEF DESCRIPTION OF THE DRAWINGS

In the following, the invention is described with reference to the appended figures which give background explanations and represent specific embodiments of the invention. The scope of the invention is however not limited to the specific features disclosed in the context of the figures, wherein

FIG. 1 illustrates the basic steps of the method according to the first aspect;

FIG. 2 illustrates the basic steps of the method according to the second aspect;

FIG. 3 shows an embodiment of the present invention, specifically the methods according to the first and second aspects;

FIG. 4 shows an embodiment of the present invention;

FIG. 5 is a CT image showing a surface of the patients upper body when the arms are in an upper position;

FIG. 6 is a camera surface image;

FIG. 7 is an (IGRT) x-ray image that was acquired at the same point in time as the camera surface and is used to double-check upper arm posture; and

FIG. 8 is a schematic illustration of the system according to the sixth aspect.

### DESCRIPTION OF EMBODIMENTS

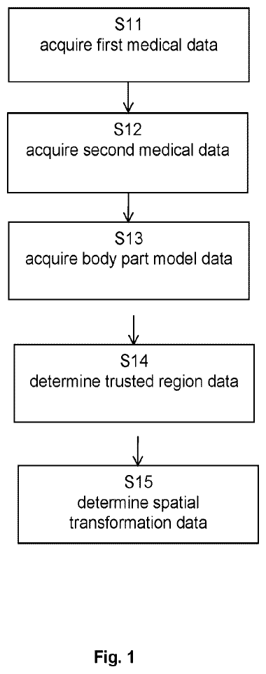

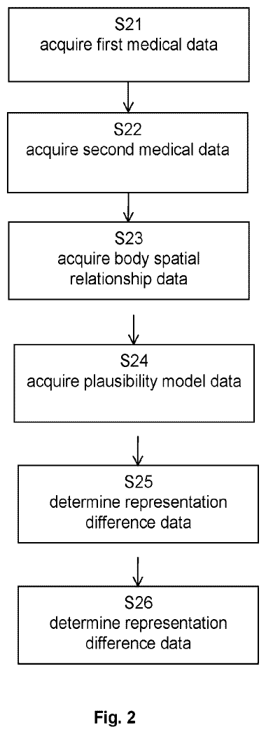

FIG. 1 illustrates the basic steps of the method according to the first aspect, in which step S11 encompasses acquisition of the first medical data, step S12 encompasses acquisition of the second medical data and subsequent step S13 encompasses acquisition of the body part model data. These data sets serve as a basis for determining the trusted region data in step S14 and the spatial transformation data in step S15.

FIG. 1 illustrates the basic steps of the method according to the second aspect, in which step S21 encompasses acquisition of the first medical data, step S22 encompasses acquisition of the second medical data and subsequent step S23 encompasses acquisition of the spatial relationship data. Then, the plausibility model data is acquired in step S24. These data sets serve as a basis for determining the representation difference data in step S25 and the plausibility check data in step S26.

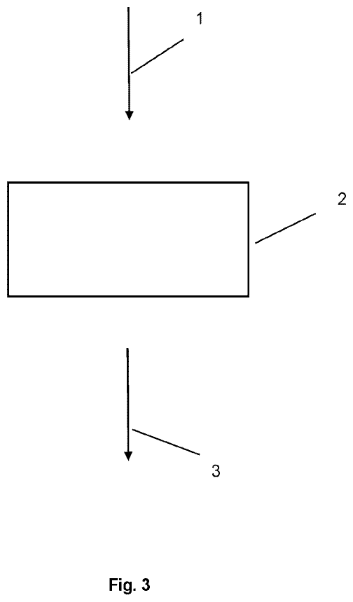

FIG. 3 illustrates an embodiment of the present invention that includes all essential features of the invention. In this embodiment, the entire data processing which is part of the method according to the first aspect is performed by a computer 2. Reference sign 1 denotes the input of data acquired by the method according to the first aspect into the computer 2 and reference sign 3 denotes the output of data determined by the method according to the first aspect or the method according to the second aspect.

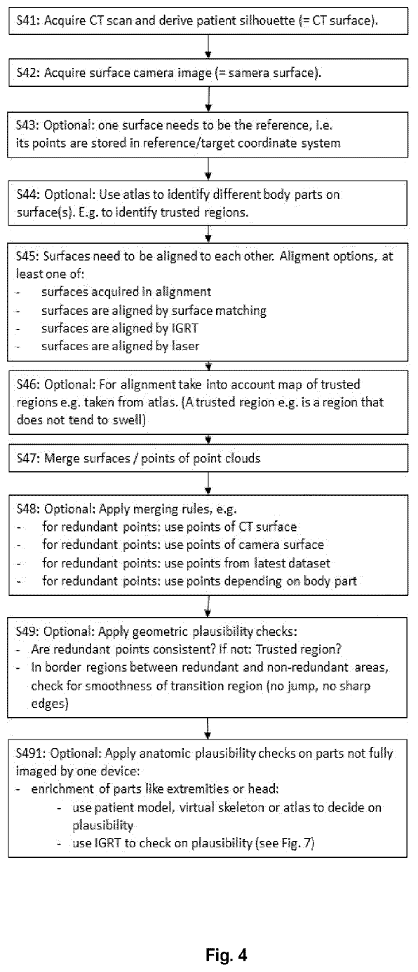

FIG. 4 shows an embodiment of the present invention. In step S41, a CT planning image of the patient's upper body is acquired, followed by step S42 in which a surface camera image is acquired. In optional step S43, one surface as defined as the reference, i.e. its points are stored in a reference/target coordinate system. In optional step S4, a digital model of the anatomical body part such as an atlas is used to identify different body parts on the surface(s) to identify trusted regions. In step S45, the surfaces are aligned to each other using at least one of:
acquiring the surfaces in alignment;
surfaces are aligned by surface matching;
surfaces are aligned by IGRT (image-guided radiation treatment, for example image-guided radiotherapy; and
surface alignment by laser.

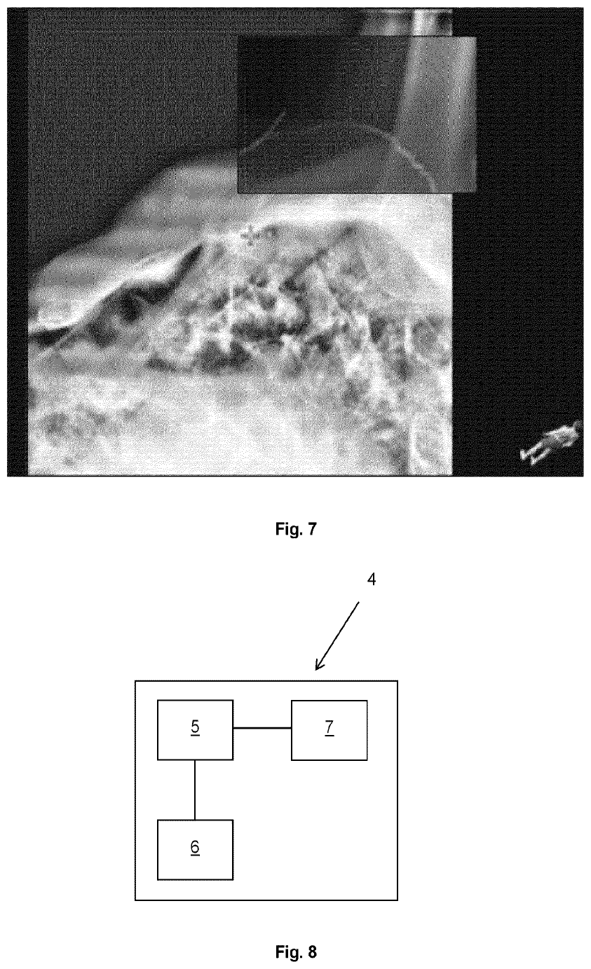

In optional additional step S46, the surfaces are aligned by taking into account map of trusted regions taken from the digital model. For example, a trusted region e.g. is an anatomical region that does not tend to swell for example due to the influence of treatment radiation. In step S47, the surfaces are merged, for example by merging the point of point clouds representing the surfaces, for example by applying the above-described merging rules described by merging rule data in step S48. In optional step S49, geometric plausibility checks are applied, including a determination whether redundant points are consistent, and if they are not by determining whether they represent part of a trusted region. In optional step S491, Optional: an anatomic plausibility check is conducted on parts of the anatomical body part not fully imaged by the surface camera imaging device, for example by:
enrichment of anatomical body parts like upper extremities or the head;
using the digital model, virtual skeleton or atlas to decide on the plausibility; and/or
using IGRT to check on plausibility (see FIG. 7).

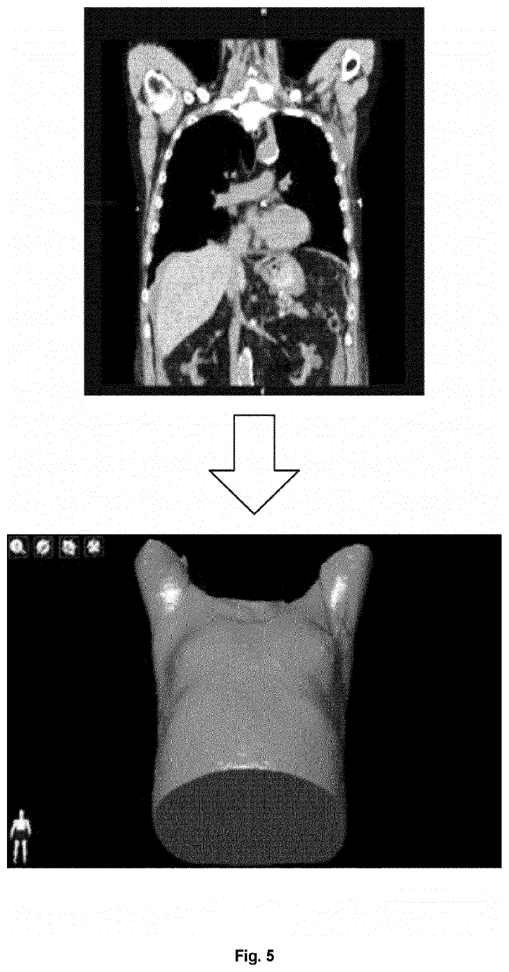

In FIG. 5, the CT (computed x-ray tomography) contour is associated with no shadowing but a comparably small field of view. Also, the CT contour is potentially outdated (e.g. due to radiation-induced swelling).

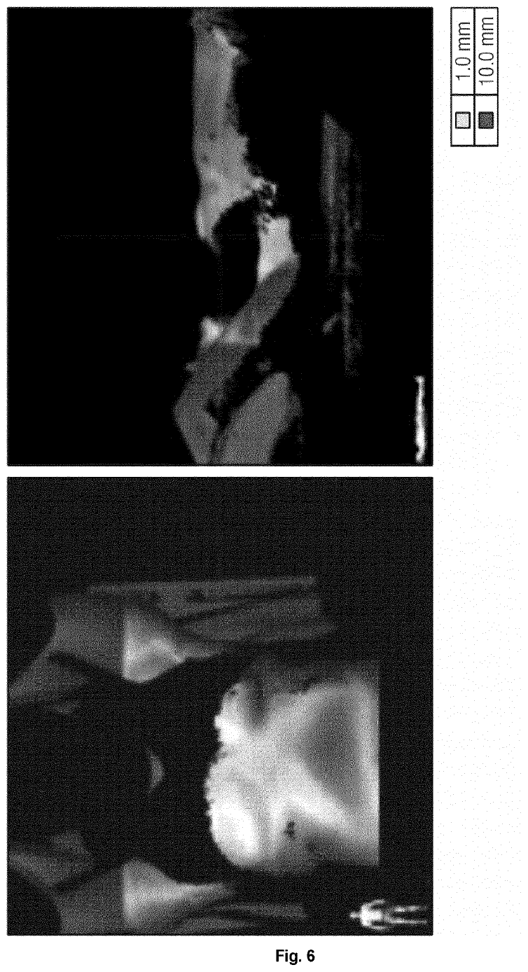

In FIG. 6, the camera surface image provides for a comparably larger field of view specifically in regard of the upper arms. However, it may be up-to-date and can be retrieved without exposing the patient to radiation. Hidden parts, e.g. behind the breast, may be present due to the position of the surface camera relative to the anatomical body part.

In the (IGRT) X-ray image shown in FIG. 7, the upper arm as imaged by the CT (small image, DRR) is compared to the upper arm as imaged in the x-ray image. The outline in the inset image represents a supplementation of the x-ray image by information available from the CT and representing an outline of the shoulder bones to determine whether the difference between the x-ray image and the CT is plausible, for example due to shadowing (for example by the upper arms) when taking the x-ray image.

Embodiments of clinical use of a hybrid surface such as the one shown in FIG. 7 are as follows:
Having a surface camera inside the CT room allows for creating the hybrid surface already during CT Scanning, and thus for treatment planning.
After successfully prepositioning/positioning the patient the underlying surfaces could be used to create a hybrid surface reference for a next treatment session.
After successfully positioning the patient using IGRT the underlying surfaces could be used to create a hybrid surface reference for a next treatment session.
After successfully guiding the patient to a planned deep-inspiration breath-hold level, the underlying surface can be used to create a hybrid surface reference for a next treatment session.
Live enrichment: Every newly retrieved surface from the camera, can be automatically enriched to a hybrid surface providing enhanced information.

FIG. 8 is a schematic illustration of the medical system 4 according to the sixth aspect. The system is in its entirety identified by reference sign 4 and comprises a computer 5, an electronic data storage device (such as a hard disc) 6 for storing at least the patient data and a medical device 7 (such as a radiation treatment apparatus). The components of the medical system 4 have the functionalities and properties explained above with regard to the sixth aspect of this disclosure.

1. A computer-implemented method of determining a spatial transformation between sets of medical image data, the method comprising:
acquiring first medical data that describes a first representation of an anatomical body part, wherein positions of the first representation are defined in a first reference system;
acquiring second medical data that describes a second representation of the anatomical body part, wherein positions of the second representation are defined in a second reference system;
acquiring body part model data that describes a digital model of the anatomical body part and at least one weight assigned to at least one unit of the digital model describing a trust assigned to the respective at least one unit;
determining trusted region data that describes a selection of at least part of at least one of the first representation and the second representation, wherein the trusted region data is determined based on the body part model data and the respective one of at least one of the first medical data and the second medical data by establishing an assignment between: i) the at least part of the respective one of the first representation and the second representation, and ii) the at least one weight; and
determining spatial transformation data based on the first medical data, the second medical data, and the trusted region data, wherein the spatial transformation data describes a spatial transformation between the first reference system and the second reference system.

2. The method according to claim 1, wherein the determining the spatial transformation data comprises determining the spatial transformation data by selecting the at least part of the respective one of the first representation and the second representation based on the assigned weight for establishing the transformation for matching the first representation with the second representation.

3. The method according to claim 1, wherein the acquiring the first representation and the second representation comprise generating the first and second representation data using different imaging modalities, wherein the first representation is generated using computed x-ray tomography and the second representation is generated using a point cloud generating device comprising a surface camera.

4. The method according to claim 1, further comprising
acquiring threshold data describing a threshold for the at least one weight; and
determining selection data based on the body part model data and the threshold data, wherein the selection data describes whether the at least part of the respective one of the first representation and the second representation is to be determined as part of the selection,
wherein the determining the trusted region data comprises determining the trusted region data based on the selection data.

5. The method according to claim 4, wherein the at least part of the respective one of the first representation and the second representation is determined to be part of the selection based on the at least one weight assigned to the at least part of the respective one of the first representation and the second representation fulfilling a predetermined relationship to the threshold.

6. The method according to claim 1, wherein the acquiring the first and second medical data that describes the first and second representations of the anatomical body part comprises acquiring first and second medical data that describes first and second representations of an exterior surface of a patient's body.

7. The method according to claim 1, further comprising
determining merging data based on the spatial transformation data and the first medical data and the second medical data, wherein the merging data describes a merging of the first representation and the second representation, comprising a merging of point clouds extracted from the first representation and the second representation.

8. The method according to claim 7, wherein the merging comprises a selection of at least part of at least one of the first representation and the second representation, and corresponding constituents of the other one of the at least one of the first representation and the second representation.

9. The method according to claim 7, further comprising acquiring merging rule data that is used as a basis for determining the merging data, wherein the merging rule data describes merging rules indicating that if the first representation and the second representation, comprising point clouds extracted from the first representation and the second representation, comprise data points that are at least substantially redundant, the respective data point from the respective one of the first or second representation or the data point from the one of the first medical data or the second medical data which was generated later in time or a data point from the one of the first medical data or the second medical data that depends on the identity of the anatomical body part is included in the merging.

10. A computer-implemented method of determining a plausibility of a difference in image content between sets of medical image data, the method comprising:
acquiring first medical data that describes a first representation of an anatomical body part, wherein positions of the first representation are defined in a first reference system;
acquiring second medical data that describes a second representation of at least part of the anatomical body part, wherein positions of the second representation are defined in a second reference system;
acquiring spatial relationship data that describes a spatial transformation between the first reference system and the second reference system;
acquiring plausibility model data that describes a digital model of the anatomical body part and information about degrees of freedom of the digital model;
determining representation difference data based on the first medical data, the second medical data, and the spatial transformation data, wherein the representation difference data describes a difference between the first representation and the second representation; and
determining plausibility check data based on the plausibility model data and the second medical data and the representation difference data, wherein the plausibility check data describes the plausibility of the difference.

11. The method according to claim 10, wherein the difference data describes a difference in depicted anatomy.

12. The method according to claim 10, wherein the second representation describes less of the anatomical body part than the first representation.

13. The method according to claim 10, wherein the digital model comprises a skeleton model.

14. The method according to claim 10, further comprising
acquiring medical image data describing a two-dimensional image of a part of the anatomical body part which is described by the second representation; and
acquiring the plausibility model data based on the medical image data by extracting the image constituents describing the part of the anatomical body part and generating the digital model from the extracted image constituents.

15. The method according to claim 10, further comprising
determining difference supplement data based on the second medical data and the representation difference data, wherein the difference supplement data describes a supplementation of the second representation with the difference in consideration of the degrees of freedom of the digital model,
wherein the plausibility check data is determined based on the body part model data and the difference supplement data.

16. The method according to claim 15, wherein the determining the plausibility check data comprises determining correspondence between the supplementation and the first representation.

17. The method according to claim 16, wherein the plausibility check data describes that the difference is plausible if a comparison of the first representation and the second representation results in that the correspondence at least substantially exists.

18. The method according to claim 10, further comprising generating the first representation and the second representation using different imaging modalities, wherein the first representation beenis generated using computed x-ray tomography and the second representation is generated using a point cloud generating as surface camera device.

19. The method according to claim 10, wherein the plausibility check data describes that the difference is plausible,
wherein the method further comprises determining surface data based on the second medical data, wherein the surface data describes an exterior surface of the at least part of the anatomical body part.

20. A non-transitory computer-readable storage medium storing instructions thereon that, when the instructions are executed by a processor device of an associated computer, cause the computer to perform a method of determining a spatial transformation between sets of medical image data, by:
acquiring first medical image data that describes a first representation of an anatomical body part, wherein positions of the first representation are defined in a first reference system;
acquiring second medical image data that describes a second representation of the anatomical body part, wherein positions of the second representation are defined in a second reference system;
acquiring body part model data that describes a digital model of the anatomical body part and at least one weight assigned to at least one unit of the digital model describing a trust assigned to the respective at least one unit;
determining trusted region data that describes a selection of at least part of at least one of the first representation and the second representation, wherein the trusted region data is determined based on the body part model data and the respective one of at least one of the first medical image data and the second medical image data by establishing an assignment between: i) the at least part of the respective one of the first representation and the second representation, and ii) the at least one weight; and
determining spatial transformation data based on the first medical image data, the second medical image data, and the trusted region data, wherein the spatial transformation data describes a spatial transformation between the first reference system and the second reference system.

21-23. (canceled)
